(19) United States
(12) Patent Application Publication
(10) Pub. No.: US 2024/0421295 A1
(43) Pub. Date: Dec. 19, 2024

(54) METHOD FOR PREPARING MOLYBDENUM BASED SELF DOPED LITHIUM NEGATIVE ELECTRODE MATERIAL FROM MOLYBDENUM-CONTAINING WASTE CATALYST, NEGATIVE ELECTRODE MATERIAL, AND LITHIUM-ION BATTERY

(71) Applicant: CHINA UNIVERSITY OF PETROLEUM-BEIJING, Beijing (CN)

(72) Inventors: Guoyong HUANG, Beijing (CN); Jiawei WEN, Beijing (CN); Xueli WANG, Beijing (CN); Wenjie ZHANG, Beijing (CN); Maolin TIAN, Beijing (CN); Tongjun SHEN, Beijing (CN); Mingshuai WU, Beijing (CN)

(21) Appl. No.: 18/744,914

(22) Filed: Jun. 17, 2024

(30) Foreign Application Priority Data
Jun. 19, 2023 (CN) 202310725141.9

(51) Int. Cl. H01M 4/525; C01G 49/00; H01M 4/02; H01M 10/0525

(52) U.S. Cl. CPC H01M 4/525; C01G 49/0018; H01M 10/0525; C01P 2002/54; C01P 2002/72; C01P 2004/03; C01P 2006/40; H01M 2004/027

(57) ABSTRACT

A method for preparing molybdenum-based self-doped lithium-ion battery negative electrode material from molybdenum-containing waste catalyst includes: (1) calcinating and mechanically activating a waste hydrogenation catalyst containing molybdenum trioxide and aluminum oxide to obtain an oil-free and carbon-free micron-sized waste catalyst powder; (2) mixing the waste catalyst powder with sodium carbonate to obtain a mixture, and subjecting the mixture to thermal treatment to selectively convert molybdenum trioxide in the waste catalyst into sodium molybdate to obtain a clinker; (3) subjecting the clinker to leaching with water being used as a leaching agent, and collecting a leaching solution; and (4) mixing the leaching solution with a solution of a polyol containing a ferrous salt, subjecting the resulting mixture to a hydrothermal reaction, and collecting produced self-Al-doped ferrous molybdate to obtain the molybdenum-based self-doped lithium-ion battery negative electrode material.

### TECHNICAL FIELD

The present invention belongs to the field of recycling and high-value utilization of waste catalysts as secondary resources, and relates to a method for preparing a lithium-ion battery material directly from a waste, and in particular to a method for preparing molybdenum-based self-doped lithium-ion battery negative electrode material from molybdenum-containing waste catalyst, a negative electrode material, and a lithium-ion battery.

### BACKGROUND

In China, hydrogenation catalysts is mainly utilized in the fields of oil refining industry, chemical industry and coal chemical industry. In the oil refining industry, hydrogenation catalysts are essential catalysts used to convert heavy crude oil into high-quality light oil products. Hydrogenation catalysts used in oil refining industry in China are mainly produced by domestic companies. In the chemical industry, hydrogenation catalysts are widely used in producing products such as lubricants, synthetic resins, synthetic rubbers, etc. Deactivation time of hydrogenation catalysts varies depending on their use and process conditions. Generally speaking, the deactivation time of hydrogenation catalysts for oil refining is 2-3 years, while the deactivation time of hydrogenation catalysts used in chemical and coal chemical fields may be shorter. Each year up to 400,000-500,000 tons of hydrogenation catalysts is scrapped and forms huge “urban mines”. Hydrogenation catalysts contain large amounts of critical metals, such as Ni, Co, Mo, etc. Besides, waste hydrogenation catalysts are classified as HW50 hazardous wastes in china. Proper disposal of waste hydrogenation catalysts is therefore of great economic and environmental significance.

Lithium-ion batteries are high-performance, high-energy-density batteries and are characterized by high energy density, long service life, capability of being fast charged and discharged, etc. With the rapid development of new energy industry in China, lithium-ion batteries have a good development prospect, especially in the fields of electric vehicles, portable electronics, and renewable energy. Lithium-ion battery negative electrode materials are important parts of lithium-ion batteries and have an important impact on properties of the batteries. At present, research on lithium-ion battery negative electrode materials focuses mainly on graphite materials. Although graphite has certain advantages as a lithium-ion battery negative electrode material, its theoretical specific capacity (372 mAh/g) is low, which restricts its further development. Ferrous molybdate, as a high-performance lithium-ion battery negative electrode material, has a high theoretical specific capacity (992 mAh/g), which is suitable for further development of lithium-ion batteries.

CN 112619658 A discloses a method for recycling waste hydrogenation catalyst, including: (1) subjecting a waste hydrogenation catalyst to extraction to remove oil and to calcination to remove to carbon, crushing and screening the resulting waste hydrogenation catalyst, and then mixing it with an alkali, followed by calcination; (2) impregnating the resulting calcinated waste catalyst powder with hot water, followed by filtration to obtain a filtrate and a residue, and then adding a polymer monomer I into the filtrate to obtain a solution I; (3) mixing and reacting the residue with an acid, followed by filtration to obtain a filtrate, and adding a polymer monomer II into the filtrate to obtain a solution II; and (4) subjecting the solution I and the solution II to a parallel flow gelling reaction, followed by aging, then adding an initiator into the resulting aged turbid liquid for a polymerization reaction, subjecting the resulting mixture to solid-liquid separation, followed by extrusion, drying and calcination to obtain a hydrogenation catalyst. The method can be used to directly recycle active metals and aluminum oxide in the waste catalyst to prepare a new catalyst with excellent properties, which realizes cyclic utilization of the catalyst, helps improve the environment, and reduces production cost of catalysts. However, with the rapid development of the new energy industry and the saturation of the oil industry, preparation of high-value materials from waste catalysts has become a more promising catalyst reuse route.

CN 115074554 A discloses a method for separating and recycling molybdenum and nickel from waste catalyst, including: subjecting a waste catalyst to oxygen-enriched calcination, and then subjecting the resulting calcinated product to leaching with acetic acid, followed by adding oxalic acid to form a nickel oxalate precipitate; subjecting the nickel oxalate precipitate to filtration and separation to obtain a nickel oxalate product, and then subjecting the solution to evaporation and crystallization to obtain molybdenum oxalate and molybdenum acetate; and finally converting molybdenum oxalate and molybdenum acetate into molybdenum trioxide by thermal decomposition. Compared with traditional methods for recycling molybdenum from waste catalysts, the method is simple, results in high yield of molybdenum and nickel and does not produce saline wastewater, and therefore has obvious practical values and good application prospects. However, the product prepared by the method is of low purity and low added value. Preparation of new energy materials with high added values has therefore become the research front in the field.

### SUMMARY OF THE INVENTION

In view of the above, the present invention, directed against the problems of the existing techniques such as long recycling processes, use of large amounts of waste acid and waste alkali in the recycling processes and incapability of realizing high-value utilization of recycled products, provides a method for preparing a molybdenum-based self-doped lithium-ion battery negative electrode material from molybdenum-containing waste catalyst, a negative electrode material, and a lithium-ion battery.

The method for preparing molybdenum-based self-doped lithium-ion battery negative electrode material from molybdenum-containing waste hydrogenation catalyst provided by the present invention comprises the following steps:
(1) calcinating and mechanically activating a waste hydrogenation catalyst containing molybdenum trioxide and aluminum oxide to obtain an oil-free and carbon-free micron-sized waste catalyst powder;
(2) mixing the waste catalyst powder with sodium carbonate, to obtain a mixture, and subjecting the mixture to thermal treatment to selectively convert molybdenum trioxide in the waste catalyst into sodium molybdate, to obtain a clinker;
(3) subjecting the clinker to leaching with water being used as a leaching agent, and collecting a leaching solution; and
(4) mixing the leaching solution with a polyol solution containing a ferrous salt, subjecting the resulting mixture to a hydrothermal reaction, and collecting produced self-Al-doped ferrous molybdate to obtain the molybdenum-based self-doped lithium-ion battery negative electrode material, the polyol being ethylene glycol or triethylene glycol, preferably triethylene glycol.

In the method for preparing molybdenum-based self-doped lithium-ion battery negative electrode material from molybdenum-containing waste hydrogenation catalyst, the molybdenum-containing waste hydrogenation catalyst comprises, based on its total weight, 62-65 wt % aluminum oxide, 5-7 wt % phosphorus pentoxide, 4-5 wt % nickel oxide, and 25-27 wt % molybdenum trioxide. In a specific embodiment of the present invention, the waste catalyst comprises 65 wt % aluminum oxide, 5 wt % phosphorus pentoxide, 4 wt % nickel oxide, and 25 wt % molybdenum trioxide.

In the method for preparing molybdenum-based self-doped lithium-ion battery negative electrode material from molybdenum-containing waste hydrogenation catalyst, the calcinating is performed at a temperature of 450-550° C. (e.g., 450° C. or 550° C.), with a holding time being 0.5-2 hours (e.g., 0.5 hours, 1 hour, or 2 hours) and a calcination heating rate being 5-10° C./min (e.g., 5° C./min or 10° C./min). Preferably, the calcinating is performed at a temperature of 450° C., with the holding time being 2 hours, and the calcination heating rate being 5° C./min;
the mechanical activating is ball milling, the ball milling being performed at a speed of 400-500 rpm (e.g., 400 rpm, 450 rpm, or 500 rpm), preferably 500 rpm. The waste catalyst powder is in a size of 75-100 μm, preferably 75 μm (obtained by passing through a 200-mesh sieve).

In the present invention, the inventors found that, in step (1), the adoption of the specific example of the preferred embodiment could effectively remove carbon deposition from the surface of the waste catalyst and reduce particle size of the catalyst, which was conducive to subsequent thermal treatment.

In the method for preparing molybdenum-based self-doped lithium-ion battery negative electrode material from molybdenum-containing waste hydrogenation catalyst, a mass ratio of the waste catalyst powder to sodium carbonate is 1: (0.1-0.6), which may specifically be 1:0.1, 1:0.2, 1:0.4, 1:0.5, 1:0.6, preferably 1:0.6;
the thermal treatment is performed at a temperature of 200-400° C., e.g., 400° C., 300° C., 200° C. or 250° C., for a time period of 0.5-2 hours, e.g., 2 hours or 1.5 hours, preferably at a temperature of 400° C. for a time period of 2 hours.

In a specific embodiment of the present invention, the waste catalyst powder is thoroughly mixed with sodium carbonate in an agate mortar.

In the present invention, in step (2), the catalyst powder is mixed with Na2CO3 for thermal treatment to obtain the thermally treated clinker, and during the thermal treatment process, reactions represented by the following reaction equations may occur.

MoO₃+Na₂CO₃→Na₂MoO₄+CO₂ 1

Al₂O₃+P₂O₅→2AIPO₄ 2

Al₂O₃+Na₂CO₃→2NaAlO₂+CO₂ 3

NiS+2O₂→NiSO₄ 4

MoS₂+7O₂→2MoO₃+4SO₂ 5

The temperature of the thermal treatment needs to be controlled to make reaction 1 occur and to make other reactions do not occur, and therefore the thermal treatment is performed at the specific temperature of 200-400° C. By controlling the time period of the reaction to be 0.5-2 hours, it is ensured that the waste catalyst fully reacts with sodium carbonate. Main components of the clinker are sodium molybdate, aluminium oxide, sodium carbonate, and nickel oxide.

In the method for preparing molybdenum-based self-doped lithium-ion battery negative electrode material from molybdenum-containing waste hydrogenation catalyst, a mass ratio of Mo/Al in the leaching solution is (30-50): 1, e.g., (35-50): 1, 50:1, 40:1, or 35:1;
the leaching is performed by using warm water at 40-80° C. (e.g., 50-80° C., 50° C., 60° C., 70° C., or 80° C.), for a time period of 60-120 minutes (e.g. 60 minutes), with a liquid-solid ratio being 10-20 mL/g, e.g. 20 mL/g; preferably, the leaching is performed by using warm water at a temperature of 60° C., for a time period of 60 minutes, with the liquid-solid ratio being 20 mL/g.

In the present invention, in step (3), by controlling the mass ratio of Mo/Al in the leaching solution to be (30-50): 1, the leaching solution contains sodium molybdate as a main component and also contains a small amount of aluminum; the leached residue comprises aluminium oxide and nickel oxide as main components. By further optimizing the leaching conditions, a higher leaching rate is obtained. After the leached residue is separated from the leaching solution, the leached residue is dried in a vacuum drying oven at 60° C. for 12 hours and then left for subsequent treatment. Methods for the solid-liquid separation are not specifically limited in the present invention, and the solid-liquid separation can be realized by either pressurized suction filtration or high-speed centrifugation.

In the method for preparing molybdenum-based self-doped lithium-ion battery negative electrode material from molybdenum-containing waste hydrogenation catalyst, the ferrous salt is a water-soluble ferrous salt, preferably a hydrochloride or a sulfate, or a hydrate thereof, such as ferrous sulfate tetrahydrate, ferrous sulfate heptahydrate, or ferrous chloride tetrahydrate.

In the method for preparing molybdenum-based self-doped lithium-ion battery negative electrode material from molybdenum-containing waste hydrogenation catalyst, a volume ratio of the leaching solution to the polyol solution containing the ferrous salt is 1: (1-1.2), and may specifically be 1:1, 1:1.1, or 1:1.2, preferably 1:1. The ferrous salt is present in the polyol solution containing the ferrous salt at a concentration of 0.08 −0.1 mol/L, which may specifically be 0.08 mol/L or 0.1 mol/L. The leaching solution is mixed with the polyol solution containing the ferrous salt as follows: the leaching solution is dropwise added to the polyol solution containing the ferrous salt under stirring, followed by stirring for 1-3 hours (e.g., 1 hour, 2 hours, or 3 hours) to obtain a reddish-brown solution.

In the method for preparing molybdenum-based self-doped lithium-ion battery negative electrode material from molybdenum-containing waste hydrogenation catalyst, the hydrothermal reaction is performed at a temperature of 140-180° C. (e.g., 160-180° C., 160° C., or 180° C.), for a time period of 12-24 hours (e.g., 12 hours or 24 hours).

The present invention is not particularly restricted in respect of treatment of the product resulted from the hydrothermal reaction. Specifically, the produced self-Al-doped ferrous molybdate (a yellow-brown precipitate) may be separated by centrifugation from the system after the reaction, and after the centrifugation, a self-Al-doped ferrous molybdate lithium-ion battery negative electrode material can be obtained by vacuum drying or freeze drying.

The present invention further provides a molybdenum-based self-doped lithium-ion battery negative electrode material prepared by the method according to any of the above embodiments. In the molybdenum-based self-doped lithium-ion battery negative electrode material provided in the present invention, a doping amount of aluminum is 2-3 wt %, e.g., 2 wt %.

The present invention also provides a lithium-ion battery comprising the molybdenum-based self-doped lithium-ion battery negative electrode material. The lithium-ion battery of the present invention has a negative electrode with excellent properties.

In the research process, the inventors of the present invention found that the adoption of specific thermal treatment conditions and the selection of a specific leaching agent can help to realize green and efficient leaching of valuable metal molybdenum which can be directly used for preparation of a high-value material. On the one hand, under the thermal treatment conditions adopted in the present invention, nickel and aluminum in the waste hydrogenation catalyst are effectively prevented from reacting with the additive and thus from being dissolved, which avoids effects of their dissolution on the extraction of molybdenum element. On the other hand, in the present invention, use of water as the leaching agent can realize effective transfer of sodium molybdate converted into a soluble salt during the thermal treatment into an aqueous solution, so as to realize selective separation of molybdenum.

The present invention provides a method for preparing a molybdenum-based self-doped lithium-ion battery negative electrode material from a molybdenum-containing waste catalyst, which has the following advantages. The method for preparing a molybdenum-based self-doped lithium-ion battery negative electrode material from a molybdenum-containing waste catalyst provided by the present invention is simple to operate, involves a short recycling process, and can result in high recycling rates of valuable metals as well as lithium-ion battery negative electrode materials with excellent properties.

### BRIEF DESCRIPTION OF THE DRAWINGS

FIG. 1 is a flow chart of a method for preparing molybdenum-based self-doped lithium-ion battery negative electrode material from molybdenum-containing waste catalyst according to the present invention.

FIG. 2 is an original XRD diagram of the waste catalyst in Example 1 of the present invention.

FIG. 3 is an XRD diagram of a product resulted from low-temperature thermal treatment in Example 1 of the present invention.

FIG. 4 is an SEM diagram of the product resulted from the low-temperature thermal treatment in Example 1 of the present invention.

FIG. 5 is an XRD diagram of a self-doped ferrous molybdate lithium-ion battery negative electrode material synthesized in Example 1 of the present invention.

FIG. 6 is an energy spectrum of the self-doped ferrous molybdate lithium-ion battery negative electrode material synthesized in Example 1 of the present invention.

FIG. 7 is a CV curve of the self-doped ferrous molybdate lithium-ion battery negative electrode material synthesized in Example 1 of the present invention.

### DETAILED DESCRIPTION

The present invention is described in further detail below in conjunction with specific embodiments, which are intended to clarify, rather than limiting the present invention. The embodiments provided below may serve as a guide for further improvement by those skilled in the art and do not limit the present invention in any way.

Experimental methods used in the following examples are conventional methods unless otherwise specified, and materials, reagents, etc., used are commercially available unless otherwise specified.

A formula used in the following examples is as follows:
(1) Leaching rate

$${x}_{i} = \frac{{C}_{i} \times n \times V \times {10}^{- 6}}{{w}_{i} \times m} \times 100 \%$$

In the formula, xᵢ is the leaching rate of an element and is expressed in %; n is the dilution factor of a sample; V is the volume of a leaching solution and is expressed in mL; Cᵢ is the concentration of each element tested by ICP and is expressed in mg/L; m is the mass of an added raw material of the sample and is expressed in g; and wᵢ is the mass percentage of each element in the raw material and is expressed in %.

In the following examples, the molybdenum-containing aluminum-based waste hydrogenation catalyst contains, based on its total weight, 65 wt % aluminum oxide, 5 wt % phosphorus pentoxide, 4 wt % nickel oxide, and 25 wt % molybdenum trioxide.

### Example 1

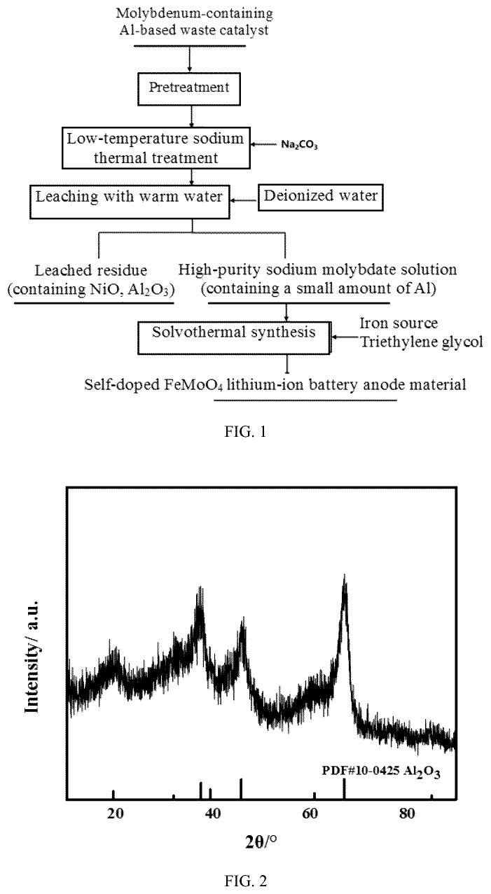

Example 1 provides a method for preparing molybdenum-based self-doped lithium-ion battery negative electrode material from molybdenum-containing waste hydrogenation catalyst, a flow chart of which is shown in FIG. 1. The method included the following steps.
(1) 10 g of a waste catalyst was placed in a corundum crucible and then sent to a muffle furnace for calcination (with a calcination temperature being 450° C., holding time being 2 hours, and a heating rate being 5° C./min). After being cooled, the sample was took out and placed into a ball mill for ball milling at a speed of 500 rpm, obtaining 8.54 g of a first material. The first material was passed through a 200-mesh sieve for later use (with the resulting powder being in a size of 75 μm).
(2) 3 g of the first material and 1.8 g of sodium carbonate were fully ground and mixed in a mortar, and then transferred to a corundum crucible and put into a muffle furnace for thermal treatment (with a thermal treatment temperature being 400° C., and thermal treatment time being 2 hours), obtaining 4.29 g of a thermally treated clinker. The thermally treated clinker contained sodium molybdate, aluminium oxide, sodium carbonate, and nickel oxide.
(3) 1 g of the above thermally treated clinker was put in a 100-mL beaker, followed by adding 20 mL of deionized water. The clinker was then subjected to leaching with warm water in a water bath at 60° C. for 1 hour, followed by centrifugation at a low speed to obtain a first leaching solution and a first leached residue. The first leaching solution was collected for later use, and the first leached residue was dried in a drying oven at 60° C. for 12 hours to obtain a dry sample.
(4) 1.12 g of ferrous chloride tetrahydrate was dissolved in 50 mL of a triethylene glycol solution. 50 mL of the above first leaching solution was added to the triethylene glycol solution, followed by continuous stirring for 1 hour to obtain a reddish-brown solution. The resulting solution was transferred into a polytetrafluoroethylene liner of a hydrothermal autoclave for hydrothermal reaction (with a hydrothermal temperature being 180° C. and hydrothermal time being 12 hours). After being cooled, the sample was took out, centrifuged, and dried to obtain a self-Al-doped ferrous molybdate lithium-ion battery negative electrode material.

Leaching rates of aluminum and molybdenum in this example are shown in Table 1. Under the conditions of this example, a leaching rate of aluminum of 0.13% and a leaching rate of molybdenum of 99.69% were realized, and separation of aluminum and molybdenum was realized. A mass ratio of Mo/Al in the leaching solution was 50:1.

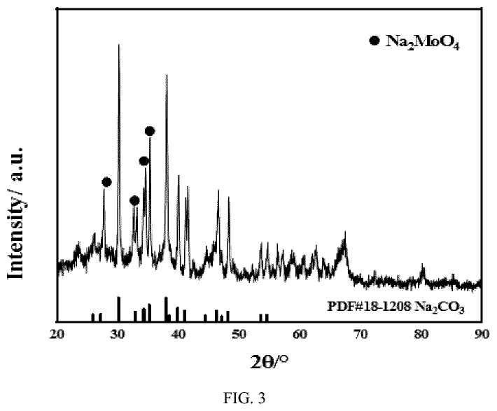

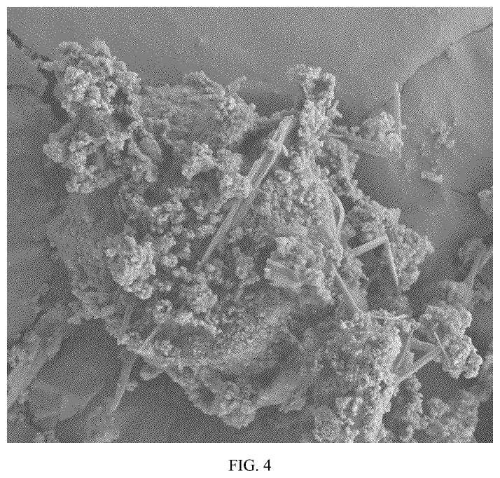

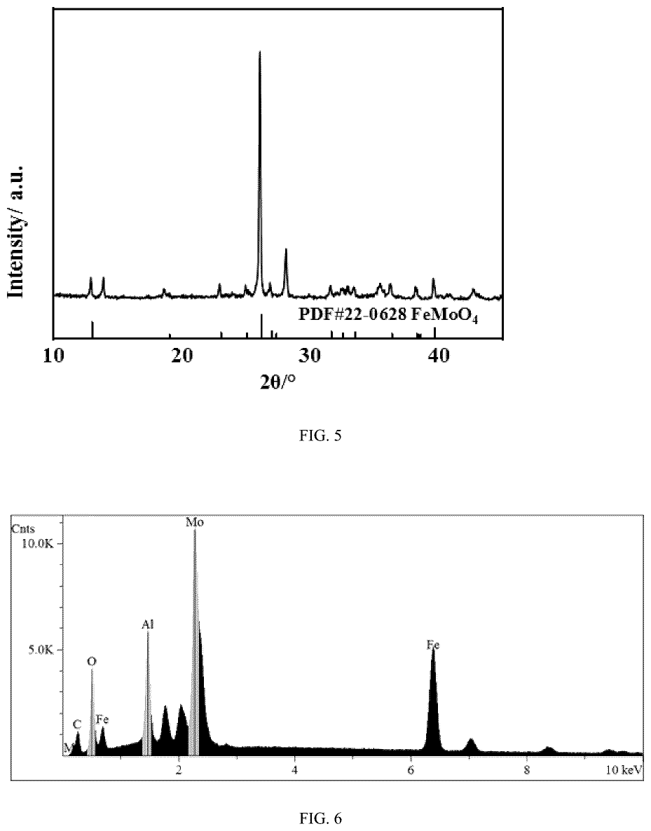

The present invention provides an XRD diagram of the original waste catalyst, an XRD diagram of the thermally treated product obtained from the thermal treatment in Example 1, an SEM diagram of the thermally treated product obtained from the thermal treatment in Example 1, an XRD of the self-doped ferrous molybdate negative electrode material synthesized in Example 1, and an energy spectrum of the ferrous molybdate lithium-ion battery negative electrode material synthesized in Example 1, which are shown in FIGS. 2-6, respectively. FIG. 2 is the original XRD diagram of the waste catalyst in Example 1. As can be seen from FIG. 2, there are many humps in the XRD diagram of the original catalyst, which indicates that the original catalyst has poor crystallinity, which may be caused by the presence of carbon in the catalyst. Moreover, the original catalyst only exhibits peaks of Al2O3, which may be because of the high content of Al2O3 in the catalyst. FIG. 3 is the XRD diagram of the product resulted from the low-temperature thermal treatment in Example 1. As can be seen from FIG. 3, the main peak of the material at this time is Na2CO3, which indicates that Na2CO3 is excessive in the reaction process; peaks of Na2MoO4 can also be seen in the figure, which indicates that the reaction selected by the present invention has occurred. FIG. 4 is the SEM diagram of the product resulted from the low-temperature thermal treatment in Example 1. As can be seen from FIG. 4, the structure of the material has undergone obvious changes at this time (a layered structure has begun to show). FIG. 5 is the XRD diagram of the self-doped ferrous molybdate lithium-ion battery negative electrode material synthesized in Example 1, and FIG. 6 is the energy spectrum of the self-doped ferrous molybdate lithium-ion battery negative electrode material synthesized in Example 1 of the present invention, indicating that a self-Al-doped ferrous molybdate battery material has been successfully prepared in Example 1. FIGS. 1-6 further verify the process and principles of the present invention for preparing a self-doped ferrous molybdate lithium-ion battery negative electrode material.

With tin foil being used as weighing paper, and with active substance: conductive agent: binder=7:2:1, 0.35 g of an active material and 0.1 g of acetylene black were weighted, poured into a mortar and ground and mixed until there was no color difference and the resulting powder was not sticky. A small beaker was took and a rotor was placed into the breaker, followed by adding dropwise 0.7143 g of PVDF (7%). The solid powder resulted from the grinding was then put into the small beaker, followed by dropwise adding NMP as a solvent repeatedly in a small amount at a time until a honey-like viscous slurry was obtained. The beaker was then sealed with parafilm, followed by stirring for 24 hours. The well stirred slurry was evenly applied on copper foil by a coating machine, and put into a vacuum drying oven for drying at 90° C. for 12 hours. After that, the resulting pole piece was cut into small discs by a sheet-punching machine. The small discs were then weighed separately and collected for later encapsulation with lithium pieces to make button cells.

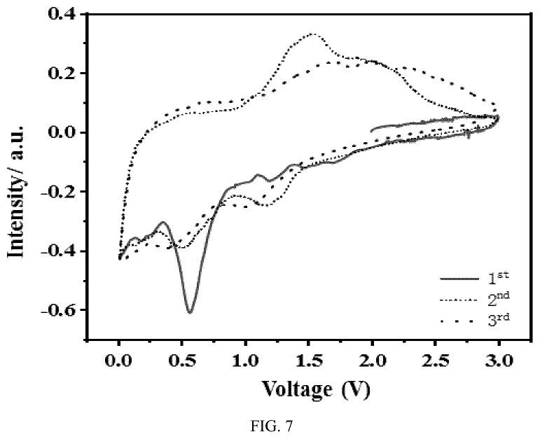

FIG. 7 is a CV curve of the self-doped ferrous molybdate lithium-ion battery negative electrode material synthesized in Example 1. At a rate of 0.5C, the initial discharge specific capacity of the material synthesized in Example 1 reaches 953.6 mAh/g, and after 100 cycles, the capacity remains at 389.6 mAh/g (as shown in Table 2). This indicates that the material prepared has excellent properties.

### Example 2

This example provides a method for preparing molybdenum-based self-doped lithium-ion battery negative electrode material from molybdenum-containing waste hydrogenation catalyst, a flow chart of which is shown in FIG. 1. The method included the following steps.
(1) 15 g of a waste catalyst was placed in a corundum crucible and then sent to a muffle furnace for calcination (with a calcination temperature being 550° C., holding time being 0.5 hours, and a heating rate being 10° C./min). After being cooled, the sample was took out and placed into a ball mill for ball milling at a speed of 400 rpm, obtaining 13.25 g of a first material. The first material was passed through a 200-mesh sieve for later use, and the sieved powder is in a size of 75 μm.
(2) 5 g of the first material and 3 g of sodium carbonate were fully ground and mixed in a mortar, and then transferred to a corundum crucible and put into a muffle furnace for thermal treatment (with a thermal treatment temperature being 300° C., and thermal treatment time being 2 hours), obtaining 7.26 g of a thermally treated clinker. The thermally treated clinker contained sodium molybdate, aluminium oxide, sodium carbonate, and nickel oxide.
(3) 5 g of the above thermally treated clinker was put in a 200-mL beaker, followed by adding 100 mL of deionized water. The clinker was then subjected to leaching with warm water in a water bath at 70° C. for 1 hour, followed by centrifugation at a low speed to obtain a first leaching solution and a first leached residue. The first leaching solution was collected for later use, and the first leached residue was dried in a drying oven at 60° C. for 12 hours to obtain a dry sample.
(4) 2.15 g of ferrous sulfate heptahydrate was dissolved in 80 mL of a triethylene glycol solution. 80 mL of the above first leaching solution was added to the triethylene glycol solution, followed by continuous stirring for 1 hour to obtain a reddish-brown solution. The resulting solution was transferred into a polytetrafluoroethylene liner of a hydrothermal autoclave for hydrothermal reaction (with a hydrothermal temperature being 180° C. and hydrothermal time being 24 hours). After being cooled, the sample was took out, centrifuged, and dried to obtain a self-doped ferrous molybdate lithium-ion battery negative electrode material.

Leaching rates of aluminum and molybdenum in this example are shown in Table 1. Under the conditions of this example, with the thermal treatment temperature in step (2) being set to 300° C., a leaching rate of aluminum of 0.15% and a leaching rate of molybdenum of 98.79% could be realized, and separation of aluminum and molybdenum was realized. A mass ratio of Mo/Al in the leaching solution was 50:1.

The prepared ferrous molybdate battery material was tested for its properties (test conditions are the same as those adopted in Example 1). The results show that at a rate of 0.5C, the initial discharge specific capacity of the material synthesized in Example 2 reached 1010.9 mAh/g, and after 100 cycles, the capacity remained at 361.6 mAh/g (as shown in Table 2). This indicates that the prepared material has excellent properties.

### Example 3

Example 3 provides a method for preparing a molybdenum-based self-doped lithium-ion battery negative electrode material from a molybdenum-containing waste hydrogenation catalyst, a flow chart of which is shown in FIG. 1. The method included the following steps.
(1) 20 g of a waste catalyst was placed in a corundum crucible and then sent to a muffle furnace for calcination (with a calcination temperature being 550° C., holding time being 1 hour, and a heating rate being 10° C./min). After being cooled, the sample was took out and placed into a ball mill for ball milling at a speed of 450 rpm, obtaining 17.86 g of a first material. The first material was passed through a 200-mesh sieve for later use (with the resulting powder being in a size of 75 μm).
(2) 8 g of the first material and 4 g of sodium carbonate were fully ground and mixed in a mortar, and then transferred to a corundum crucible and put into a muffle furnace for thermal treatment (with a thermal treatment temperature being 200° C., and thermal treatment time being 2 hours), obtaining 11.54 g of a thermally treated clinker. The thermally treated clinker contained sodium molybdate, aluminium oxide, sodium carbonate, and nickel oxide.
(3) 10 g of the above thermally treated clinker was put in a 500-ml beaker, followed by adding 200 mL of deionized water. The clinker was then subjected to leaching with warm water in a water bath at 80° C. for 1 hour, followed by centrifugation at a low speed to obtain a first leaching solution and a first leached residue. The first leaching solution was collected for later use, and the first leached residue was dried in a drying oven at 60° C. for 12 hours to obtain a dry sample.
(4) 0.80 g of ferrous chloride tetrahydrate was dissolved in 50 mL of a triethylene glycol solution. 50 mL of the above first leaching solution was added to the triethylene glycol solution, followed by continuous stirring for 1 h to obtain a reddish-brown solution. The resulting solution was transferred into a polytetrafluoroethylene liner of a hydrothermal autoclave for hydrothermal reaction (with a hydrothermal temperature being 160° C. and hydrothermal time being 24 hours). After being cooled, the sample was took out, centrifuged, and dried to obtain a self-Al-doped ferrous molybdate lithium-ion battery negative electrode material.

Leaching rates of aluminum and molybdenum in this example are shown in Table 1. Under the conditions of this example, with the thermal treatment temperature in step (2) being set to 200° C., a leaching rate of aluminum of 0.25% and a leaching rate of molybdenum of 97.54% could be realized, and separation of aluminum and molybdenum was realized. A mass ratio of Mo/Al in the leaching solution was 40:1.

The prepared ferrous molybdate battery material was tested for its properties (test conditions are the same as those adopted in Example 1). Results of the testing show that at a rate of 0.5C, the material synthesized in Example 3 has a initial discharge specific capacity of up to 997.3 mAh/g, and the capacity remains at 364.3 mAh/g after 100 cycles (as shown in Table 2). This indicates that the prepared material has excellent properties.

### Example 4

This example adopted a method similar to that used in Example 1 to prepare a molybdenum-based self-doped lithium-ion battery negative electrode material from molybdenum-containing waste hydrogenation catalyst, except that in step (2), amounts of the first material and sodium carbonate used were 5 g and 1 g, respectively, i.e., a ratio of the amount of the additive to the amount of the first material was 0.2.

Leaching rates of aluminum and molybdenum in this example are shown in Table 1. A mass ratio of Mo/Al in the leaching solution was 40:1. Properties of the prepared battery material are shown in Table 2.

### Example 5

This example adopted a method similar to that used in Example 1 to prepare a molybdenum-based self-doped lithium-ion battery negative electrode material from molybdenum-containing waste hydrogenation catalyst, except that in step (2), the thermal treatment temperature was 250° C., and the thermal treatment time was 1.5 hours.

Leaching rates of aluminum and molybdenum in this example are shown in Table 1. A mass ratio of Mo/Al in the leaching solution was 40:1. Properties of the prepared battery material are shown in Table 2.

### Example 6

This example adopted a method similar to that used in Example 1 to prepare a molybdenum-based self-doped lithium-ion battery negative electrode material from molybdenum-containing waste hydrogenation catalyst, except that in step (3), the leaching temperature was 50° C.

Leaching rates of aluminum and molybdenum in this example are shown in Table 1. A mass ratio of Mo/Al in the leaching solution was 35:1. Properties of the prepared battery material are shown in Table 2.

### Example 7

This example adopted a method similar to that used in Example 1 to prepare a molybdenum-based self-doped lithium-ion battery negative electrode material from molybdenum-containing waste hydrogenation catalyst, except that in step (3), the leaching temperature was 40° C.

Leaching rates of aluminum and molybdenum in this example are shown in Table 1. A mass ratio of Mo/Al in the leaching solution was 50:1. Properties of the prepared battery material are shown in Table 2.

### Comparative Example 1

This comparative example adopted a method similar to that used in Example 1 to prepare a molybdenum-based self-doped lithium-ion battery negative electrode material from molybdenum-containing waste hydrogenation catalyst, except that in step (1), no pretreatment of calcination for carbon removal was carried out.

Leaching rates of aluminum and molybdenum in this comparative example are shown in Table 1. A mass ratio of Mo/Al in the leaching solution was 50:1. Properties of the prepared battery material are shown in Table 2.

### Comparative Example 2

This comparative example adopted a method similar to that used in Example 1 to prepare a molybdenum-based self-doped lithium-ion battery negative electrode material from molybdenum-containing waste hydrogenation catalyst, except that in step (2), sodium carbonate was not added in the thermal treatment.

Leaching rates of aluminum and molybdenum in this comparative example are shown in Table 1. Properties of the prepared battery material are shown in Table 2.

### Comparative Example 3

This comparative example adopted a method similar to that used in Example 1 to prepare a molybdenum-based self-doped lithium-ion battery negative electrode material from a molybdenum-containing waste hydrogenation catalyst, except that in step (3), the leaching temperature was 25° C.

Leaching rates of aluminum and molybdenum in this comparative example are shown in Table 1. A mass ratio of Mo/Al in the leaching solution was 40:1. Properties of the prepared battery material are shown in Table 2.

### Comparative Example 4

This comparative example adopted a method similar to that used in Example 1 to prepare a molybdenum-based self-doped lithium-ion battery negative electrode material from molybdenum-containing waste hydrogenation catalyst, except that in step (3), the leaching time was 10 minutes.

Leaching rates of aluminum and molybdenum in this comparative example are shown in Table 1. A mass ratio of Mo/Al in the leaching solution was 40:1. Properties of the prepared battery material are shown in Table 2.

### Comparative Example 5

This comparative example adopted a method similar to that used in Example 1 to prepare a molybdenum-based self-doped lithium-ion battery negative electrode material from molybdenum-containing waste hydrogenation catalyst, except that in step (3), the solid-liquid ratio in the leaching was 10 mL/g.

Leaching rates of aluminum and molybdenum in this comparative example are shown in Table 1. A mass ratio of Mo/Al in the leaching solution was 35:1. Properties of the prepared battery material are shown in Table 2.

### Comparative Example 6

This comparative example adopted a method similar to that used in Example 1 to prepare a molybdenum-based self-doped lithium-ion battery negative electrode material from molybdenum-containing waste hydrogenation catalyst, except that in step (4), the leaching solution used was replaced by 0.08 M sodium molybdate solution.

Leaching rates of aluminum and molybdenum in this comparative example are shown in Table 1. Properties of the prepared battery material are shown in Table 2.

### Comparative Example 7

This comparative example adopted a method similar to that used in Example 1 to prepare a molybdenum-based self-doped lithium-ion battery negative electrode material from molybdenum-containing waste hydrogenation catalyst, except that in step (4), the hydrothermal temperature was 120° C.

Leaching rates of aluminum and molybdenum in this comparative example are shown in Table 1. A mass ratio of Mo/Al in the leaching solution was 30:1. Properties of the prepared battery material are shown in Table 2.

### Comparative Example 8

This comparative example adopted a method similar to that used in Example 1 to prepare a molybdenum-based self-doped lithium-ion battery negative electrode material from molybdenum-containing waste hydrogenation catalyst, except that in step (2), the thermal treatment temperature was 700° C.

Leaching rates of aluminum and molybdenum in this comparative example are shown in Table 1. A mass ratio of Mo/Al in the leaching solution was 4:3. Properties of the prepared battery material are shown in Table 2.

TABLE 1
Leaching rates of aluminum and molybdenum
in examples and comparative examples

| | Leaching rate of | Leaching rate of |
|---|---|---|
| | molybdenum | aluminum |
| Example 1 | 99.69% | 0.13% |
| Example 2 | 98.79% | 0.15% |
| Example 3 | 97.54% | 0.25% |
| Example 4 | 97.61% | 0.16% |
| Example 5 | 95.44% | 0.34% |
| Example 6 | 93.21% | 0.59% |
| Example 7 | 92.11% | 1.02% |
| Comparative Example 1 | 89.61% | 0.22% |
| Comparative Example 2 | 0.44% | 0.52% |
| Comparative Example 3 | 88.61% | 0.46% |
| Comparative Example 4 | 92.65% | 0.88% |
| Comparative Example 5 | 93.15% | 0.21% |
| Comparative Example 6 | 99.69% | 0.13% |
| Comparative Example 7 | 99.69% | 0.13% |
| Comparative Example 8 | 91.62% | 38.55% |

As can be seen from Table 1, the method provided by the present invention can be used to not only efficiently recycle molybdenum element, but also realize separation of nickel and molybdenum in the waste catalyst and retain a certain amount of aluminum, by way of which self-doping of aluminum is realized.

TABLE 2
Properties of battery materials prepared
in examples and comparative examples

| | Initial discharge | |
|---|---|---|
| | specific capacity | Capacity after 100 |
| | (mAh/g) | cycles/ (mAh/g) |
| Example 1 | 953.6 | 389.6 |
| Example 2 | 1010.9 | 361.6 |
| Example 3 | 997.3 | 364.3 |
| Example 4 | 993.5 | 385.7 |
| Example 5 | 851.3 | 293.4 |
| Example 6 | 833.9 | 248.6 |
| Example 7 | 756.8 | 285.4 |
| Comparative Example 1 | 963.4 | 275.6 |
| Comparative Example 2 | 836.1 | 264.3 |
| Comparative Example 3 | 843.6 | 298.3 |
| Comparative Example 4 | 736.6 | 223.4 |
| Comparative Example 5 | 751.3 | 213.3 |
| Comparative Example 6 | 762.3 | 229.3 |
| Comparative Example 7 | 712.6 | 243.9 |
| Comparative Example 8 | 496.2 | 30.6 |

As can be seen from Table 2, the self-Al-doped ferrous molybdate lithium-ion battery negative electrode materials prepared by the present invention have excellent properties.

The above is a detailed description of the present invention. For those skilled in the art, with parameters, concentrations and conditions being equivalent, the present invention may be implemented within a wider range without departing from the spirit and scope of the present invention. Although special embodiments are given in the present invention, it should be understood that further improvements may be made to the present invention. In short, according to the principles of the present invention, the present application is intended to include any change, use or improvement of the present invention, including changes deviating from the scope of disclosure in the present application but made by conventional art known in the art.

1. A method for preparing molybdenum-based self-doped lithium-ion battery negative electrode material from molybdenum-containing waste hydrogenation catalyst, wherein the method comprises the following steps:
(1) calcinating and mechanically activating a waste hydrogenation catalyst containing molybdenum trioxide and aluminum oxide to obtain an oil-free and carbon-free micron-sized waste catalyst powder;
(2) mixing the waste catalyst powder with sodium carbonate to obtain a mixture, and subjecting the mixture to thermal treatment to selectively convert molybdenum trioxide in the waste catalyst into sodium molybdate to obtain a clinker;
(3) subjecting the clinker to leaching with water being used as a leaching agent, and collecting a leaching solution; and
(4) mixing the leaching solution with a polyol solution containing a ferrous salt, subjecting the resulting mixture to a hydrothermal reaction, and collecting produced self-Al-doped ferrous molybdate to obtain a molybdenum-based self-doped lithium-ion battery negative electrode material; wherein the polyol is ethylene glycol or triethylene glycol.

2. The method for preparing molybdenum-based self-doped lithium-ion battery negative electrode material from molybdenum-containing waste hydrogenation catalyst, according to claim 1, wherein the molybdenum-containing waste hydrogenation catalyst comprises, based on its total weight, 62-65 wt % aluminum oxide, 5-7 wt % phosphorus pentoxide, 4-5 wt % nickel oxide, and 25-27 wt % molybdenum trioxide.

3. The method for preparing molybdenum-based self-doped lithium-ion battery negative electrode material from molybdenum-containing waste hydrogenation catalyst according to claim 1, wherein:
the calcinating is performed at a temperature of 450-550° C., with a holding time being 0.5-2 hours and a calcination heating rate being 5-10° C./min;
the mechanical activating is ball milling, wherein the ball milling is performed at a speed of 400-500 rpm; and
the waste catalyst powder is in a size of 75-100 μm.

4. The method for preparing molybdenum-based self-doped lithium-ion battery negative electrode material from molybdenum-containing waste hydrogenation catalyst according to claim 1, wherein:
a mass ratio of the waste catalyst powder to sodium carbonate is 1: (0.1-0.6); and
the thermal treatment is performed at a temperature of 200-400° C. for a time period of 0.5-2 hours.

5. The method for preparing molybdenum-based self-doped lithium-ion battery negative electrode material from molybdenum-containing waste hydrogenation catalyst according to claim 1, wherein:
a mass ratio of Mo/Al in the leaching solution is (30-50): 1; and
the leaching is performed by using warm water at 40-80° C., for a time period of 60-120 minutes, with a liquid-solid ratio being 10-20 mL/g.

6. The method for preparing molybdenum-based self-doped lithium-ion battery negative electrode material from molybdenum-containing waste hydrogenation catalyst according to claim 1, wherein the ferrous salt is a water-soluble ferrous salt.

7. The method for preparing molybdenum-based self-doped lithium-ion battery negative electrode material from molybdenum-containing waste hydrogenation catalyst according to claim 1, wherein:
a volume ratio of the leaching solution to the polyol solution containing the ferrous salt is 1: (1-1.2);
the ferrous salt is present in the polyol solution containing the ferrous salt at a concentration of 0.08-0.1 mol/L;
the leaching solution is mixed with the triethylene glycol solution containing the ferrous salt as follows: the leaching solution is dropwise added to the triethylene glycol solution containing the ferrous salt under stirring, followed by stirring for 1-3 hours to obtain a reddish-brown solution.

8. The method for preparing molybdenum-based self-doped lithium-ion battery negative electrode material from molybdenum-containing waste hydrogenation catalyst according to claim 1, wherein the hydrothermal reaction is performed at a temperature of 140-180° C., for a time period of 12-24 hours.

9. A molybdenum-based self-doped lithium-ion battery negative electrode material prepared by the method according to claim 1.

10. A lithium-ion battery, comprising the molybdenum-based self-doped lithium-ion battery negative electrode material according to claim 9.
